(19) United States
(12) Patent Application Publication
(10) Pub. No.: US 2022/0034348 A1
(43) Pub. Date: Feb. 3, 2022

(54) BLIND RIVET NUT, BLIND RIVET NUT ARRANGEMENT AND SETTING METHOD

(71) Applicant: NEWFREY LLC, New Britain, CT (US)

(72) Inventors: Thorsten NEUL, Giessen (DE); Stefan SCHNEIDER, Giessen (DE)

(21) Appl. No.: 17/500,554

(22) Filed: Oct. 13, 2021

Related U.S. Application Data
(63) Continuation of application No. PCT/EP2020/059038, filed on Mar. 31, 2020.

(30) Foreign Application Priority Data
May 3, 2019 (EP) 19172594.4

(51) Int. Cl. F16B 19/10; F16B 37/06

(52) U.S. Cl. CPC F16B 19/1072; F16B 37/067

(57) ABSTRACT

The present invention relates to a blind rivet nut allowing an easy automated setting comprising a head forming a flange, a shank comprising a head end, a foot end and a cylindrical bore extending along a longitudinal axis (X) from the head end to the foot end, the bore having a first bore segment near the foot end and a second bore segment near the head end, the wall surrounding the second bore segment forming a deformable region of the shank and having an external wall diameter, the foot end having a foot end diameter, wherein the foot end of the shank comprises a tapered chamfer making a foot end angle of 21 to 25 degrees with the longitudinal axis (X), and wherein the ratio of the foot end diameter to the external wall diameter is between 0.65 and 0.82.

### CROSS-REFERENCE TO RELATED APPLICATIONS

This application is a continuation of international PCT/EP2020/059038, filed Mar. 31, 2020 which claims priority from European Patent Application No. 19172594.4, filed May 3, 2019, the disclosures of which are incorporated herein by reference in their entirety.

### BACKGROUND OF THE INVENTION

The present invention relates to a blind rivet nut, a blind rivet nut arrangement and a setting method. More particularly, the present invention relates to a blind rivet nut allowing an automated setting without a perfect alignment between the axis of the blind rivet nut and the axis of the hole in which the blind rivet nut is destined to be arranged.

Blind rivet nuts are used in thin sheet applications as a means of thread reinforcement. A blind rivet nut typically has an elongate body, that is generally cylindrical or hexagonal in cross section, and hollow for the major part of its length, with one end being either closed (blind) or open. Part of the hollow portion is threaded to receive a setting tool or bolt. A flange is formed at an open end of the blind rivet nut remote from the threaded end and extends laterally therefrom. The flange extends beyond the periphery of the hollow body and has a generally flat face that abuts the surface of an outer layer or sheet of material.

Installation of the blind rivet nut commences with the blind rivet nut being threaded onto a threaded mandrel of a setting tool and together inserting the blind rivet through preformed apertures of one or more layers of sheets of materials. On initiation of the setting cycle the setting tool mandrel, still in engagement in the blind rivet nut, is pulled rearwards towards the flange of the blind rivet nut thereby causing deformation of the blind rivet nut body walls beyond the side of the workpiece remote from the operator and sandwiching the, or each sheet of material, against the face of the flange.

Several patent documents disclose such kind of blind rivet nuts. The European patent EP1953398 B1 for instance is directed to a blind rivet nut comprising a shank and a head with at least two different bore segments in the inside of the blind rivet nut. A tapered end of the blind rivet nut is provided and allow a better insertion into an aperture.

U.S. Ser. No. 10/012,257 BB discloses a component arrangement with a blind rivet nut. The blind rivet nut is also provided with a chamfer at its foot end.

Such blind rivets and blind rivet arrangements are adapted to provide a better insertion into an aperture. However, there is still a need to improve such blind rivet nuts and their insertions.

For instance, to ensure a perfect assembly and notably an anti-rotation of the assembled blind rivet nut, the diameter of the hole and the diameter of the blind rivet nut body are dependent from each other with a close tolerance. However, the close tolerance between the diameter of the hole and the diameter of the blind rivet nut body might be difficult to ensure in an industrial environment.

Besides, the insertion of the blind rivet nut into the hole is usually facilitated by providing a chamfer at the end of the blind rivet nut body as disclosed in the prior art mentioned. However, the presence of the chamfer alone might not be sufficient for some automated or fully-automated setting of blind rivet nuts.

### BRIEF SUMMARY OF THE INVENTION

The object of the present invention is to go some way towards solving or at least mitigating the problem above and providing a blind rivet nut with improved setting capability, such that for instance a fully-automated setting can easily be made. The object of the present invention is further to provide a blind rivet nut arrangement and a blind rivet nut setting method which allows a pre-determined and defined maximal offset between the center of the hole and the axis of the rivet, thus facilitating the insertion without decreasing the joining or assembly quality.

To this aim, according to the invention, it is provided a blind rivet nut according to claim 1.

Such blind rivet nut is easy to manufacture and can easily be mounted in the hole of a workpiece, even if the axis of the hole and the nut are not entirely centered. Besides, several tests have surprisingly shown that such blind rivet nuts can easily be set fully-automated by a blind rivet nut setting robot. Indeed, the specific ratio of the blind rivet nut between two diameters of the blind rivet nut associated with the specific chamfer angle perfectly allows an automation of the setting process, reducing manufacturing time.

In some embodiment the ratio of the foot end diameter to the external wall diameter is between 0.74 and 0.81. Such ratio is particularly advantageous, since it provides a well-balanced rivet which can easily be set.

In some embodiment the foot end angle is of about 23 degrees. Due to the foot end angle of about 23 degrees the blind rivet nut can better slide into the aperture

In some embodiment a first internal chamfer is provided between the first and the second bore segment. The first internal chamfer makes an angle of 60 degrees with the longitudinal axis. The first internal chamfer assists the attachment and the centering of a threaded mandrel attached to a setting machine.

In some embodiment a second internal chamfer is provided between the two bore segments of the bore. This second internal chamfer assists the centering and the engaging of the threaded mandrel of the blind rivet setting device with an internal thread of the blind rivet nut.

In some embodiment the blind rivet nut is made of a material chosen from for example steel, brass, stainless steel or aluminum. The material could also be chosen from alloys of the aforesaid materials. The material of the blind rivet nut could therefore be chosen in function of the materials destined to be connected by the blind rivet nut or in which the blind rivet nut will be inserted in.

In some embodiment the shank has an outer surface in the form of a regular polygonal prism or of a cylinder. The regular polygonal form of the shank increases the resistance against a rotation of the assembled blind rivet nut in an aperture of one or more layers of material. The cylindrical form is easy to manufacture.

The present invention is further directed to a blind rivet nut arrangement according to independent claim 8. Such arrangement is easy to set up.

In some embodiment the aperture is provided with a contour having ten to fourteen protrusions. This geometry of the aperture additionally supports the equalization of a possibly occurring offset. For instance, the aperture is provided with twelve protrusions.

Finally, the present invention is directed to a blind rivet nut setting method according to claim 10.

The method allows the setting of a blind rivet nut with an offset up to 1.5 mm. The assembly can thus be completely automated, and the manufacturing time is reduced. Indeed, several tests have proven that such offset allows a full automation without a further particular hole-finding device, for instance attached to the head of a setting machine. Besides, such offset allows a time-efficient setting.

In some embodiment a straightening step is performed after the insertion of the shank into the aperture. The straightening step ensures that the head of the blind rivet nut (the flange) and a surface of the workpiece are mostly parallel to each other.

In some embodiment the workpiece is provided with the aperture. The aperture is provided with a contour having ten to fourteen protrusions. For instance, the aperture is provided with twelve protrusions. With the contour with 12 protrusions a cladding circle will become bigger than a cladding circle of for example a normally used hex hole. So, this geometry of the aperture additionally supports the equalization of a possibly occurring offset.

### BRIEF DESCRIPTION OF THE DRAWINGS

Other advantages and characteristics will readily appear from the following description of embodiments, provided as non-limitative examples, in reference to the accompanying drawings.

FIG. 1 is a side view of the inventive blind rivet nut.

FIG. 2 shows the blind rivet nut of FIG. 1 in sectional view A-A.

FIG. 3 is a sectional view of the blind rivet nut and a sheet material before assembly.

FIG. 4 is a top view of a contour of an aperture in the sheet material.

FIG. 5 is a sectional view of a blind rivet nut in the inserted state.

FIG. 6 is a schematic flow chart of the inventive blind rivet nut setting method.

### DETAILED DESCRIPTION OF THE PREFERRED EMBODIMENTS

On the different figures, the same reference signs designate identical or similar elements.

FIG. 1 shows a side view of a blind rivet nut 10. The blind rivet nut 10 comprises a head 12 forming a flange and a shank 14. The shank 14 extends along a longitudinal axis X. For example, the shank 14 of the blind rivet nut 10 may have for example a length L of about 19 mm and an external wall diameter D1 of about 13,5 mm. In another embodiment the blind rivet nut 10 could have a length L of the shank 14 of about 16,5 mm and an external wall diameter D1 of about 11,5 mm. In a further embodiment the external wall diameter D1 of the blind rivet nut 10 may be of about 15,5 mm and the length L of the shank 14 may be of about 22,75 mm. The blind rivet nut 10 may also have an external wall diameter D1 of about 9 mm and a length L of the shank 14 of about 14 mm.

The blind rivet nut 10 is for instance centered about the longitudinal axis X. The shank 14 comprises a head end 16 and a foot end 18. The head end is arranged proximal to and in the continuity of the head 12, wherein the foot end 18 forms a free end. The foot end 18 comprises a foot end angle A with the longitudinal axis X of the blind rivet nut 10. The foot end angle is a non-zero angle (A >0°). The foot end angle A is realized by a tapered chamfer 22 at the food end 18 of the shank 14. Further the shank 14 has an outer surface in the form of a regular polygonal prism or of a cylinder. The regular polygonal form of the shank 14 increases the resistance against a rotation of the assembled blind rivet nut 10 in an aperture of a sheet material.

The blind rivet nut 10 is made of a material chosen from for example steel, brass, stainless steel or aluminum. The material could also be chosen from alloys of the aforesaid materials.

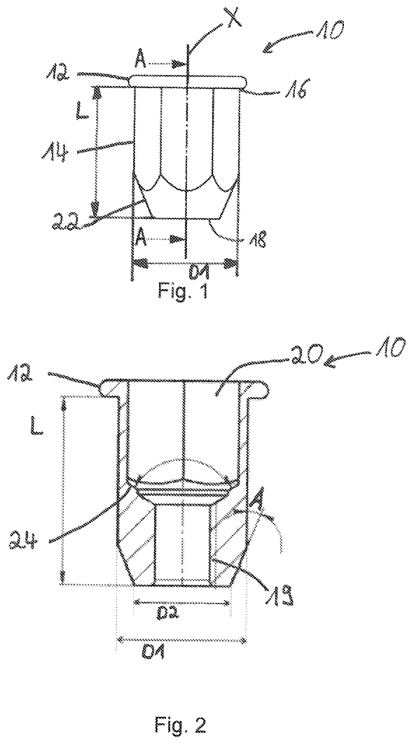

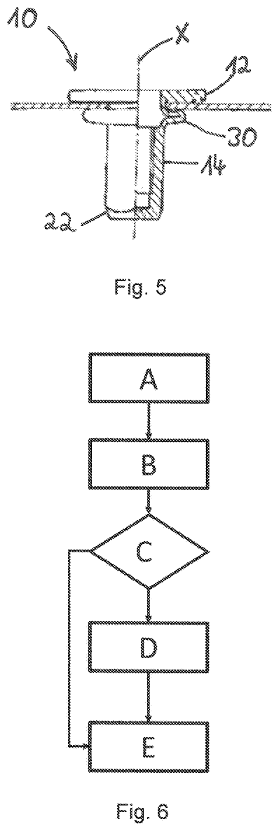

FIG. 2 shows the blind rivet nut 10 depicted in FIG. 1 in sectional view A-A. The shank 14 comprises a cylindrical bore 20 which extends along the longitudinal axis X from the head end 16 to the foot end 18. In other words, the bore 20 may form a through hole. In another embodiment, the bore can be a blind hole, as depicted in FIG. 5. The bore 20 comprises a first bore segment near the foot end 18. The first bore segment is provided with an internal thread 19. The bore further comprises a second bore segment near the head end 16. The diameter of the second bore segment is greater than the diameter of the first bore segment. The wall surrounding the second bore segment forms a deformable region of the shank 14 and has an external wall diameter D1. The different diameters supporting a better deformation of the deformable region of the shank 14 on the one hand and the provision of a high-quality, load-bearing thread on the other hand.

The foot end 18 of the shank has a foot end diameter D2 which is different from D1. The ratio of the foot end diameter D2 to the external wall diameter D1 is between 0,65 and 0,82, and more particularly between 0.72 and 0.81. For example, the ratio of the foot end diameter to the external wall diameter is between 0.74 and 0.81. Finally, said ratio can be smaller 0.77.

A first internal chamfer 24 is provided between the two bore segments. The first internal chamfer 24 assists the attachment and the centering of a threaded mandrel in the bore 20 during the setting of the blind rivet nut. Blind rivet nut setting tools with threaded mandrels are well known and will not be further described. The angle of the first internal chamfer 24 to the longitudinal axis X is in the range from 55° to 65°, ideally 60°.

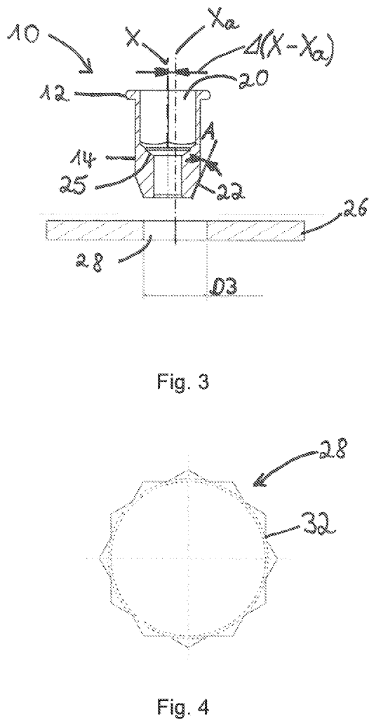

FIG. 3 shows a sectional view of the blind rivet nut 10 for the insertion in a workpiece 26. FIG. 3 illustrates the blind rivet nut 10 and only one workpiece 26. However, in another embodiment (not represented), the blind rivet nut 10 could also be inserted into more than one layer of material. The blind rivet nut 10 could be inserted for example from one layer up to five layers.

For the insertion of the blind rivet nut 10 into the workpiece 26, the workpiece 26 is pre-formed with an aperture 28 with a diameter D3. The aperture 28 is centered around an aperture axis Xa. The diameter D3 of the aperture 28 comprises dimensions which are similar to the external wall diameter D1 of the blind rivet nut 10, such that the shank 14 can be inserted into the aperture, whereas the head 12 rests against the surface directly at the periphery of the aperture. Similar means that the diameter D3 of the aperture is a little bit bigger than the external wall diameter D1 so that the blind rivet nut 10 can be inserted into the aperture 28. A little big bigger means for instance from 0,1 to 0,9 mm, ideally from 0,1 to 0,6 mm bigger.

To facilitate the insertion of the blind rivet nut 10 into the aperture 28, the foot end 18 of the blind rivet nut body is usually provided with a chamfer 22. The chamfer 22 thus facilitates the insertion of the blind rivet nut 10 within the aperture 28. The foot end 18 of the shank comprises the tapered chamfer 22 making the foot end angle A. The foot angle A is between 21° and 25° with the longitudinal axis X. For instance, the foot end angle A is of about 23°.

The setting of the blind rivet nut 10 is preferably done with a blind rivet nut setting device (not illustrated). The blind rivet nut setting device is preferably arranged on a robot or robot arm and is also driven by the robot or robot arm.

A second internal chamfer 25 is provided between the two bore segments of the bore 20. This second internal chamfer 25 assists the centering and the engaging of the threaded mandrel of the blind rivet setting device with the internal thread 19. The second internal chamfer 25 is arranged between the first internal chamfer 24 and the foot end 18, respectively the inner thread 19.

The ratio of the foot end diameter D2 to the external wall diameter D1, the foot end angle A of the blind rivet nut 10 eases a fully automated blind rivet setting method driven by a robot, notably without the necessity of a precise hole-finding device or a precise tolerance adjustment fixed on the head of a setting tool. The two internal chamfers 24, 25 may further improve the automated setting.

The aforementioned ratio makes an offset Δ(X-Xa) up to 1,5 mm between the longitudinal axis X and the aperture axis Xa possible. Thus, a possible occurring offset Δ(X-Xa) up to 1,5 mm does not prevent the insertion of the blind rivet nut 10 into the aperture 28.

A possible contour 32 for the aperture 28 in the workpiece 26 is shown in FIG. 4. However, in other embodiments, the aperture can be a circular aperture. For instance, the aperture 28 may have a round, epileptic or oval shape.

The workpiece 26 is prepared with the aperture 28 before the insertion of the blind rivet nut 10 and/or the blind rivet nut setting method is done. As shown in FIG. 4 the aperture 28 is provided with a contour. The provided contour consists of protrusions 32 which are extending to the aperture axis Xa. Preferably the contour comprises ten to fourteen of said protrusions 32. For example, the aperture 28 is provided with a contour having 12 protrusions 32. In a top view the contour can be seen as star-shaped. More particularly, the shape of the contour could be compared to the shape of a XZN screw/bolt head drive. The protrusions have the form of triangles with a first and second segment forming a tip, the tip extending towards the aperture axis Xa. The geometry or shape of the aperture 28 in the workpiece is also able to facilitate the fully automated blind rivet setting method driven by a robot.

It could also be possible that the protrusions have rounded tips. The tips may have a radius from 0,1 to 0,9.

This geometry of the aperture 28 has the advantage that there is more room left and right in the vicinity of a tip where the material can flow into during setting. This will prevent that the aperture becomes smaller and so, the nut is prevented from jamming during the insertion step.

The blind rivet nut arrangement with the blind rivet nut 10 and a workpiece is shown in FIG. 5.

The blind rivet nut arrangement comprises the blind rivet nut 10 and the workpiece 26 provided with the aperture 28. The shank 14 of the blind rivet nut 10 extends in the aperture 28, the head 12 contacts the workpiece 26 and a portion of the second bore segment is deformed forming a bulge 30. The workpiece 26 is sandwiched between the bulge 30 and the head 12.

The installation of the blind rivet nut begins with the blind rivet nut being threaded onto a threaded mandrel of a setting tool. The blind rivet nut is inserted into the aperture(s) of one or more layers of sheets of materials, for instance by a robot arm. On initiation of the setting cycle the setting tool mandrel, still in engagement in the blind rivet nut, is pulled rearwards towards the flange of the blind rivet nut thereby causing deformation of the blind rivet nut body wall (second bore segment) beyond the side of the workpiece remote from the operator and sandwiching the, or each sheet of material, against the face of the flange.

FIG. 6 is a schematic flow chart of the inventive blind rivet nut setting method.

The blind rivet nut setting method comprising a first step (step A) of providing a workpiece 26 with an aperture 28, wherein the aperture 28 is centered around an aperture axis Xa and comprises an aperture diameter D3. A blind rivet nut setting device is further provided with a blind rivet nut 10, wherein the blind rivet nut setting device is driven by a robot arm.

In a second step (step B) the blind rivet nut setting device is moved. The robot arm arranges the blind rivet nut 10 in front of the aperture 28. The longitudinal axis X and the aperture axis Xa are or can be offset up to 1,5 mm.

In a third step (step C) the shank 14 is inserted in the aperture 28. An offset between the longitudinal axis X and the aperture axis Xa up to 1,5 mm does not prevent the insertion of the present blind rivet nut 10 into the aperture 28.

In a last step (step E) the blind rivet nut 10 is set in the aperture.

It is additionally possible to perform a straightening step (step D) after the insertion of the shank 14, such that the longitudinal axis X extends perpendicular to the workpiece surface during the setting. More particularly, the straightening step consists of centering the head of the blind rivet nut setting tool with the center of the aperture after or during insertion of the blind rivet nut. The head of the blind rivet nut setting device is “straightened” to align the axis and perform the well-known Pull step for setting the blind rivet nut.

The blind rivet nut setting method can thus be done fully automatically and without any previously required hole-finding devices like sensors or video camera.

Although exemplary embodiments of the present invention have been shown and described, it will be appreciated by those skilled in the art that changes may be made to these embodiments without departing from the principles and spirit of the invention, the scope of which is defined in the appended claims and their equivalents.

### REFERENCE SIGN LIST

10 blind rivet nut
12 blind rivet nut head with a flange
14 shank
16 head end
18 foot end
19 inner thread
20 bore
22 tapered chamfer
24 first internal chamfer
25 second internal chamfer
26 workpiece
28 aperture
30 bulge
32 protrusions
A foot end angle
L length of the shank
X longitudinal axis (of the blind rivet nut)
Xa aperture axis
(Δ(X-Xa)) offset
D1 external wall diameter
D2 foot end diameter
D3 diameter of the aperture

What is claimed is:

1. A blind rivet nut for insertion into an aperture formed in one or more layers of material comprising: a head forming a flange; a shank comprising a head end, a foot end and a cylindrical bore extending along a longitudinal axis from the head end to the foot end, the bore having a first bore segment near the foot end, provided with an internal thread and a second bore segment near the head end whose diameter is greater than the diameter of the first bore segment, the wall surrounding the second bore segment forming a deformable region of the shank and includes an external wall diameter, wherein the foot end includes a foot end diameter, the foot end of the shank including a tapered chamfer making a foot end angle of 21 to 25 degrees with the longitudinal axis, and wherein the ratio of the foot end diameter to the external wall diameter is between 0.65 and 0.82.

2. The blind rivet nut of claim 1, wherein the ratio of the foot end diameter to the external wall diameter is between 0.74 and 0.81.

3. The blind rivet nut of claim 1, wherein the foot end angle is of about 23 degrees.

4. The blind rivet nut of claim 1, wherein a first internal chamfer is provided between the first bore segment and the second bore segment, and wherein the first internal chamfer makes an angle of about 60 degrees with the longitudinal axis.

5. The blind rivet nut of claim 4, wherein a second internal chamfer is provided between the first bore segment and the second bore segment.

6. The blind rivet nut of claim 1, wherein the blind rivet nut is made of a material chosen from one of steel, stainless steel, aluminium or brass.

7. The blind rivet nut of claim 1, wherein the shank has an outer surface in the form of a regular polygonal prism or of a cylinder.

8. In combination, a blind rivet nut according to claim 1 and a workpiece provided with an aperture, wherein the shank of the blind rivet nut extends in the aperture, the head contacts the workpiece and a portion of the second bore segment is deformed forming a bulge, such that the workpiece is sandwiched between the bulge and the head.

9. The blind rivet nut arrangement according to claim 8, wherein the aperture is provided with a contour having 12 protrusions.

10. A method of setting a blind rivet nut comprising the steps of:
a. providing a workpiece with an aperture, wherein the aperture is centered around an aperture axis (Xa) and comprises an aperture diameter;
b. providing a blind rivet nut setting device and a blind rivet nut according to claim 1, wherein the blind rivet nut setting device is driven by a robot arm, and wherein the external wall diameter is sensibly equal to the aperture diameter;
c. moving the blind rivet nut setting device and the blind rivet nut with the robot arm such that the blind rivet nut is facing the aperture with the longitudinal axis and the aperture axis (Xa) being offset up to 1.5 mm;
d. inserting the shank in the aperture, wherein an offset between the longitudinal axis and the aperture axis (Xa) does not prevent the insertion of the blind rivet nut into the aperture;
e. setting the blind rivet nut in the aperture.

11. The method of claim 10, wherein a straightening step is performed after the insertion of the shank, such that the longitudinal axis extends perpendicular to the workpiece surface during the setting.

12. The method of claim 10, wherein the aperture is provided with a contour having 12 protrusions.
